(19) United States
(12) Patent Application Publication
(10) Pub. No.: US 2024/0054395 A1
(43) Pub. Date: Feb. 15, 2024

(54) SYSTEM AND METHOD FOR PROVIDING PERSONAL MACHINE LEARNING MODELS

(71) Applicant: SAMSUNG ELECTRONICS CO., LTD., Suwon-si (KR)

(72) Inventor: Mete OZAY, Staines (GB)

(73) Assignee: SAMSUNG ELECTRONICS CO., LTD., Suwon-si (KR)

(21) Appl. No.: 18/206,859

(22) Filed: Jun. 7, 2023

(30) Foreign Application Priority Data
Aug. 11, 2022 (GB) 2211732.9

(51) Int. Cl. G06N 20/00

(52) U.S. Cl. CPC G06N 20/00

(57) ABSTRACT

Broadly speaking, embodiments of the present techniques provide a method and system for providing personal machine learning, ML, models. In particular, the present application provides a system for developing a training personal and personalised models to improve user experience.

### CROSS-REFERENCE TO RELATED APPLICATION(S)

This application claims priority to GB Patent Application No. 2211732.9, filed on Aug. 11, 2022, in the GB Intellectual Property Office, the disclosure of which is incorporated by reference herein in its entirety.

### BACKGROUND

### 1. Field

The present application generally relates to a method and system for providing personal machine learning, ML, models. In particular, the present application provides a system for developing a training personal and personalised models to improve user experience.

### 2. Description of the Related Art

Personalised artificial intelligence, AI, models are machine learning models which are customised for users by employing the data produced by users. Personal AI models are machine learning models which learn persona, that is, representation of experience, preference, behaviour and so on, of users, by employing the data produced by users. Many model personalisation techniques propose personalisation of pre-trained models.

The applicant has therefore identified the need for an improved system and method to provide personal ML models.

### SUMMARY

In a first approach of the present techniques, there is provided a system for providing personal machine learning, ML, models for users, the system comprising: a server, comprising a task-independent shared ML model; a user platform device, comprising a task-independent personal ML model for a user; and a user device comprising a task-specific personal ML model for the user.

The server may comprise at least one processor coupled to memory for training the task-independent shared ML model using a first training dataset.

The at least one processor of the server may train the task-independent shared ML model to learn a set of shared features.

The task-independent shared ML model may comprise a feature extractor to extract features from data in the first training dataset, and a classifier to classify the extracted features.

Training the task-independent shared ML model may comprise using any one of the following: supervised learning, unsupervised learning, semi-supervised learning, and self-supervised learning.

The user platform device may comprise at least one processor coupled to memory for training the task-independent personal ML model using a second training dataset.

The at least one processor of the user platform device may train the task-independent personal ML model to learn a set of personal features specific to the user.

Training the task-independent personal ML model may comprise using the shared features.

The task-independent personal ML model may comprise using an encoder to encode features of data in the second training dataset and the shared features, and decoder to decode the encoded features.

The second training dataset may comprise labelled data items, and if so, training the task-independent personal ML model comprise using zero-shot or few-shot learning.

Alternatively, the second training dataset may comprise labelled and unlabelled data items, and if so, training the task-independent personal ML model may comprise using any one of the following: supervised learning, unsupervised learning, semi-supervised learning, and self-supervised learning.

The user device may comprise at least one processor coupled to memory for training the task-specific personal ML model using a third training dataset.

The at least one processor of the user device may train the task-specific personal ML model to learn a set of task-specific personal features specific to the user.

Training the task-specific personal ML model may comprise using the personal features.

The third training dataset may comprise labelled data items, and if so, training the task-specific personal ML model may comprise using zero-shot or few-shot learning.

Alternatively, the third training dataset may comprise labelled and unlabelled data items, and if so, training the task-specific personal ML model may comprise using any one of the following: supervised learning, unsupervised learning, semi-supervised learning, and self-supervised learning.

The ML models may be trained to perform a computer vision task. The ML models may be trained to perform any one of the following computer vision tasks: object recognition, object detection, object tracking, scene analysis, pose estimation, image or video segmentation, image or video synthesis, and image or video enhancement.

The ML models may be trained to perform an audio analysis task. The ML models may be trained to perform any one of the following audio analysis tasks: audio recognition, audio classification, speech synthesis, speech processing, speech enhancement, speech-to-text, and speech recognition.

In a second approach of the present techniques, there is provided a computer-implemented method training task-independent personal machine learning, ML, models for a user, the method comprising: obtaining a training dataset specific to the user; obtaining, from a task-independent shared ML model, a set of shared features; and training, using the training dataset and set of shared features, the task-independent personal ML model to learn a set of personal features specific to the user.

The training may comprise: using an encoder to encode features of data in the training dataset and the shared features, and using a decoder to decode the encoded features.

The training dataset may comprise labelled data items, and if so, the training may comprise using zero-shot or few-shot learning. Alternatively, the training dataset may comprise labelled and unlabelled data items, and if so, the training may comprise using any one of the following: supervised learning, unsupervised learning, semi-supervised learning, and self-supervised learning.

The user device may be a constrained-resource device, but which has the minimum hardware capabilities to train and use a trained neural network. The user device may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge). It will be understood that this is a non-exhaustive and non-limiting list of example user devices.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

A non-transitory computer readable medium for storing computer readable program code or instructions which are executable by a processor to perform a method for suggesting at least one modality of interaction, the method comprising: obtaining a training dataset specific to the user; obtaining, from a task-independent shared ML model, a set of shared features; and training, using the training dataset and set of shared features, the task-independent personal ML model to learn a set of personal features specific to the user.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF THE DRAWINGS

Implementations of the present techniques will now be described, by way of example only, with reference to the accompanying drawings, in which:

FIG. 1 is a schematic diagram of a system for providing personal machine learning, ML, models for users;

FIG. 2 is a schematic diagram of the training of a task-independent shared ML model;

FIG. 3 is a schematic diagram of the training of a task-independent personal ML model for a user;

FIG. 4 is a schematic diagram of the training of a task-specific personal ML model for the user;

FIG. 5 is a table showing hyper-parameters of a network architecture implementing the task-independent personal ML model;

FIG. 6 is a table showing experimental results;

FIG. 7 is a schematic diagram showing the training of a shared ML model;

FIG. 8 is a schematic diagram showing the training of personal ML models using semi-supervised learning;

FIG. 9 is a schematic diagram showing the training of personal ML models using semi-supervised learning and self-supervision;

FIG. 10 is a table showing experimental results from training of personal ML models using semi-supervised learning and self-supervision;

FIG. 11 is a table showing experimental results from training models implemented using Pytorch and NNTrainer;

FIG. 12 is a table showing experimental results from training models implemented using NNTrainer;

FIG. 13 is a table showing experimental results from training models implemented using Pytorch and NNTrainer;

FIG. 14 is a table showing experimental results from training models implemented using NNTrainer;

FIG. 15 is a flowchart of example steps to train the task-independent personal ML model; and

FIG. 16 is a block diagram of a system for providing personal machine learning, ML, models for users.

### DETAILED DESCRIPTION

Broadly speaking, embodiments of the present techniques provide a method and system for providing personal machine learning, ML, models. In particular, the present application provides a system for developing a training personal and personalised models to improve user experience.

Personalized AI models are machine learning models which are customized for users employing the data produced by users, such as users of AI services (e.g., Bixby and Gallery) in Samsung devices (e.g. phone and TV). Personal AI models are machine learning models which learn persona (that is, representation of experience, preference, behaviour etc.) of users employing the data produced by users, such as users of AI services (e.g., Bixby and Gallery) in Samsung devices (e.g. phone and TV). All the prior art on model personalization propose personalization of pre-trained shared models (SMs). In contrast, the present techniques propose a system to directly construct personal models (PMs) for users that are separated from pre-trained shared models (SMs), instead of just personalizing SMs. That is, the present techniques do not propose personalization of pre-trained shared models (SMs), but instead propose to construct and train discrete personal models.

The present techniques provide a system to directly construct personal models (PMs) for users that are separated from pre-trained shared models (SMs), instead of just personalizing SMs. Disentangled Personalization allows for disentangling/detaching personal models (PMs) customized for each user, and pre-trained models (SMs), such as Massive Foundation Models, shared among users. Efficient Personalization enables only PMs to be incrementally trained using only continuously generated user data without need for updating SMs. As a result the present techniques provide improved privacy and mobility, by enabling modularity and mobility for PMs such that PMs can be deployed on embedded devices such as Samsung Smart Card. Thereby, physical security can be obtained in addition to digital security. Moreover, it can be integrated to other models of different modality.

Thus, the present techniques provide disentangled/detached discrete Models (ability to learn personal representations without need of modifying pre-trained shared models with improved computational efficiency). The present system can design and learn personal representations by only training personal models disentangled/detached from shared models with labelled and unlabelled multi-modal user data. The present techniques provide improved mobility and privacy (ability to be integrated with different shared models of different complicated tasks with improved privacy). The present system provides modular and mobile personal models, where the modularity allows for compatibility with different pre-trained shared models used in different AI services such as Speech Recognition (e.g. Bixby) and Image/Video Analysis/Camera (e.g. Gallery). The present system provides improved digital and physical privacy/security, via the deployment of “only” personal models on physical devices such as Samsung Phone and Smart Card, with improved privacy and security.

The models may be trained using unlabelled and labelled samples (ability to train shared models using supervised, unsupervised, semi-supervised and self-supervised learning methods). This enables sample efficient training of personal models. Detached modular and exclusive personal representations can be learned efficiently even using a few labelled samples with zero-shot and few-shot learning techniques. Detached modular and exclusive personal representations can be learned using both unlabelled and labelled data with supervised, unsupervised, semi-supervised and self-supervised learning techniques.

The present techniques provide incremental training of personal models (ability to incrementally learn personal representations as users generate data continuously). In other words, the present techniques enable computationally efficient incremental training, by the incremental training of only modular and exclusive personal models, without requiring personalization of large-scale shared models. Smaller personal models can resolve forgetting and plasticity better.

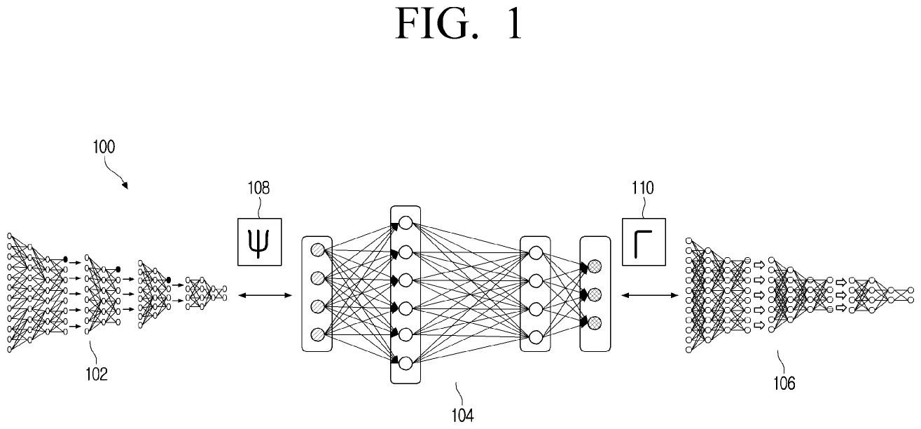

FIG. 1 is a schematic diagram of a system 100 for providing personal machine learning, ML, models for users. The system 100 comprises a task-independent shared ML model 102, a task-independent personal ML model for a user 104, and a task-specific personal ML model for the user 106. The task-independent shared ML model 102 may be deployed of edge devices (e.g. smartphones, smart fridges, smart televisions, etc.) or servers. The task-independent personal ML model for a user 104 may be deployed on smart cards, digital wallets or edge devices. The task-specific personal ML model for the user 106 may be deployed on edge devices. Shared features 108 may be provided from model 102 to model 104. Personal features 110 may be provided from model 104 to model 106.

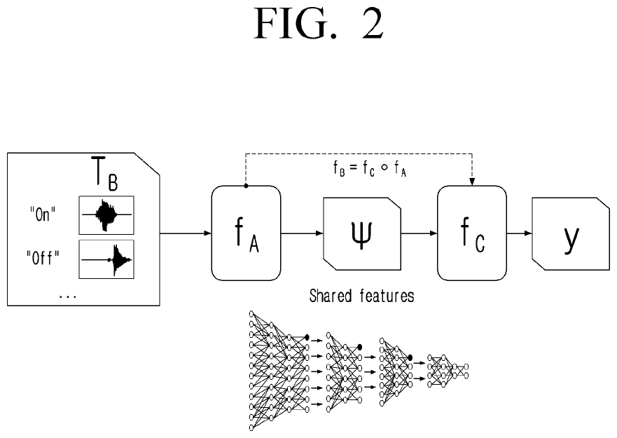

FIG. 2 is a schematic diagram of the training of a task-independent shared ML model. The shared model may be foundation AI models such as transformers. The training of shared models may be performed by edge devices or servers using datasets T_{B}.

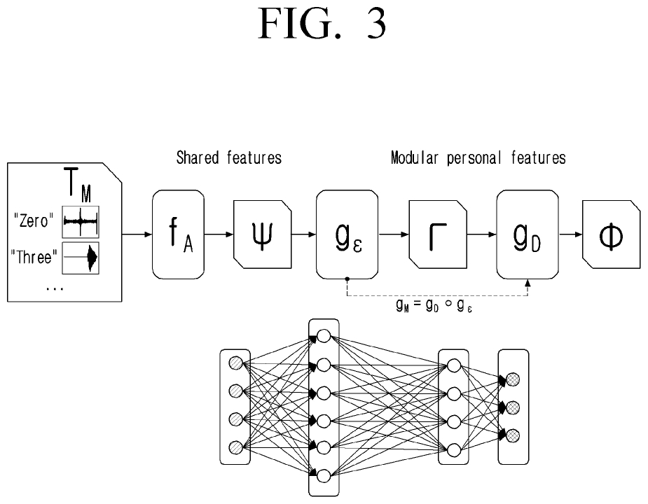

FIG. 3 is a schematic diagram of the training of a task-independent personal ML model for a user. The training may be performed on platform devices or edge devices.

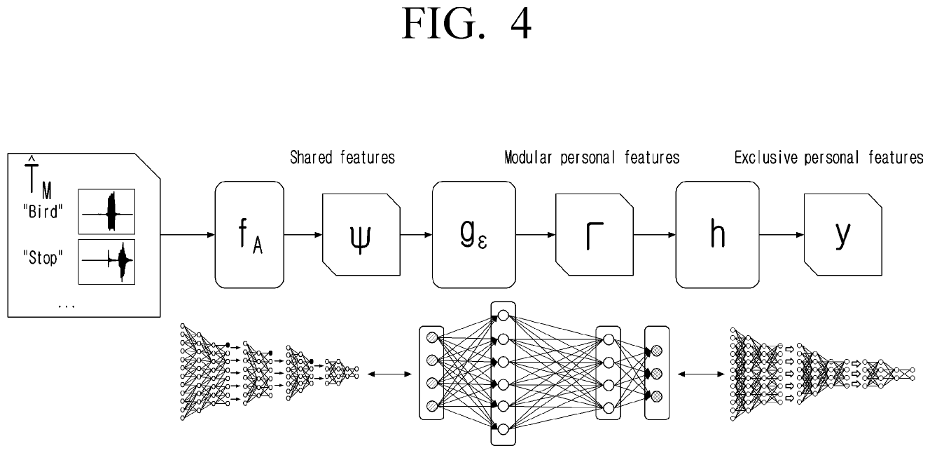

FIG. 4 is a schematic diagram of the training of a task-specific personal ML model for the user. The training may be performed on edge devices belonging to a user.

Existing techniques implement personalization on individual devices. However, this restricts mobility of personal models. Suppose that a personal model M of a user is trained on a device such as user's phone P. This model M cannot be moved to another device of the user such as another phone P, laptop L, DTV D or tablet T using existing techniques, to be integrated to existing model on the device. Advantageously, the present techniques enable learning task-independent modular personal representations which can be deployed on edge devices and can be integrated with different task-dependent exclusive personal representations.

The task-independent personal model of the present techniques may be provided on a smart card, which provides physical and digital security for the model.

Existing techniques require personalization of large-scale shared models and personal models. Large scale data is required to train large-scale shared models and personal models. Since the models are not detached, supervised training procedure for sub-models (smaller parts of large models) cannot be switched to unsupervised training, vice-versa. In contrast, advantageously, the present techniques enable sample efficient training of personal models. Detached modular and exclusive personal representations can be learned efficiently even using a few labelled samples with zero-shot and few-shot learning techniques. Detached modular and exclusive personal representations can be learned using both unlabelled and labelled data with supervised, unsupervised, semi-supervised and self-supervised learning techniques.

Furthermore, the present techniques enable computationally efficient incremental training of personal models, i.e. incremental training of only modular and exclusive personal models, without requiring personalization of large-scale shared models. Example tasks that can be performed by the personal models include, speech recognition (e.g. automatic speech recognition, ASR), and/or computer vision (e.g. class incremental object recognition, detection, semantic segmentation), and/or natural language processing (e.g. neural machine translation).

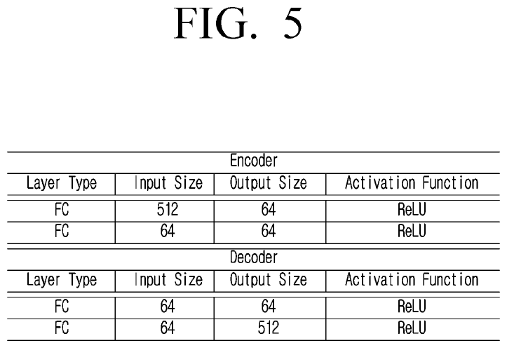

FIG. 5 is a table showing hyper-parameters of a network architecture implementing the task-independent personal ML model. The model may be used for few-shot spoken word recognition. Shared models are trained using GSC and LW datasets. Modular personal models are trained using unsupervised and supervised learning loss functions. Exclusive personal models are trained for incremental 1-shot and 5-shot learning. Shared models: Implemented using Resnet-10 architecture. Exclusive personal models: Implemented using logistic regression and nearest centroid classifiers.

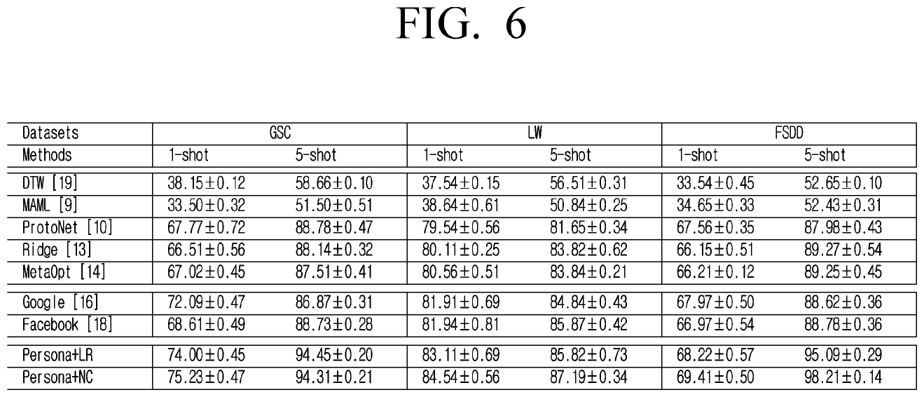

FIG. 6 is a table showing experimental results. The model may be used for few-shot spoken word recognition. Shared models are trained using the GSC dataset. Modular personal models are trained using unsupervised and supervised learning loss functions. Exclusive personal models are trained for incremental 1-shot and 5-shot learning. Shared models: Implemented using Resnet-10 architecture. Exclusive personal models: Implemented using logistic regression (LR) and nearest centroid (NC) classifiers.

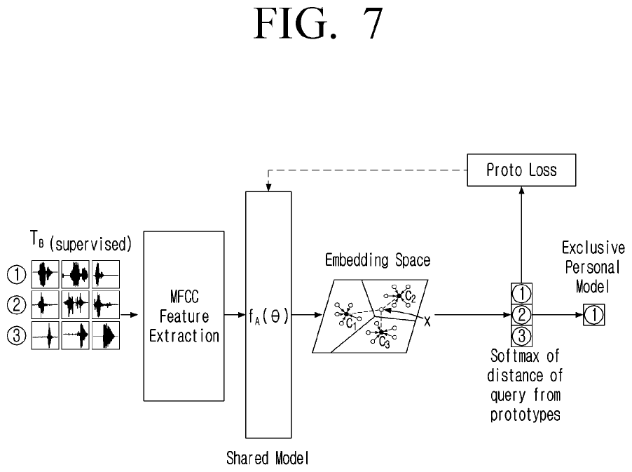

FIG. 7 is a schematic diagram showing the training of a shared ML model to perform few-shot incremental spoken word recognition, using semi-supervised learning.

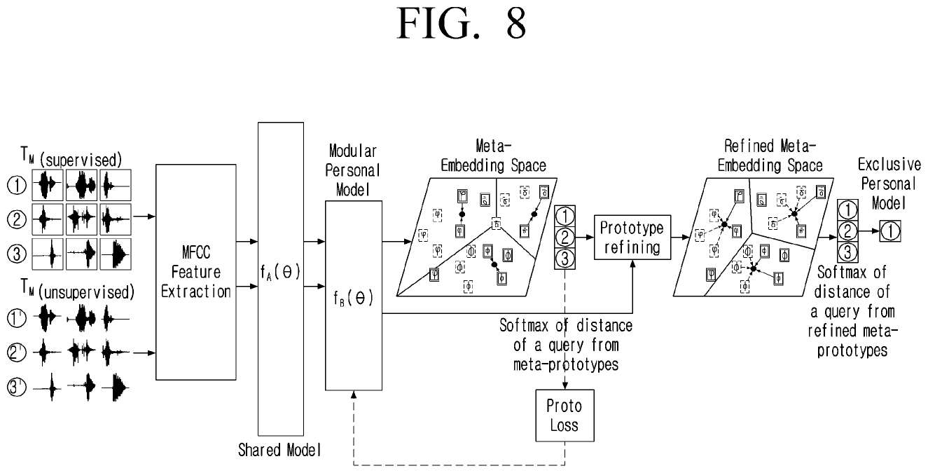

FIG. 8 is a schematic diagram showing the training of personal ML models to perform few-shot incremental spoken word recognition, using semi-supervised learning.

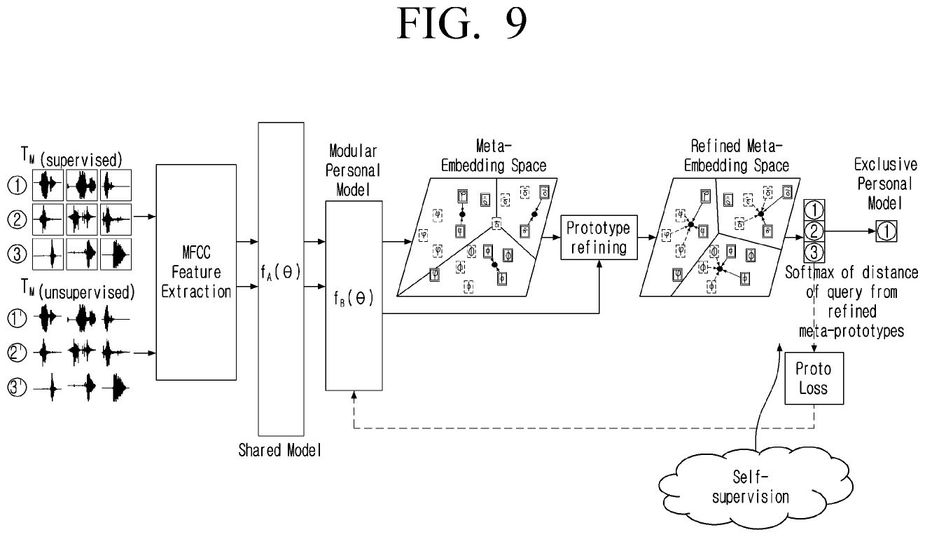

FIG. 9 is a schematic diagram showing the training of personal ML models to perform few-shot incremental spoken word recognition, using semi-supervised learning and self-supervision.

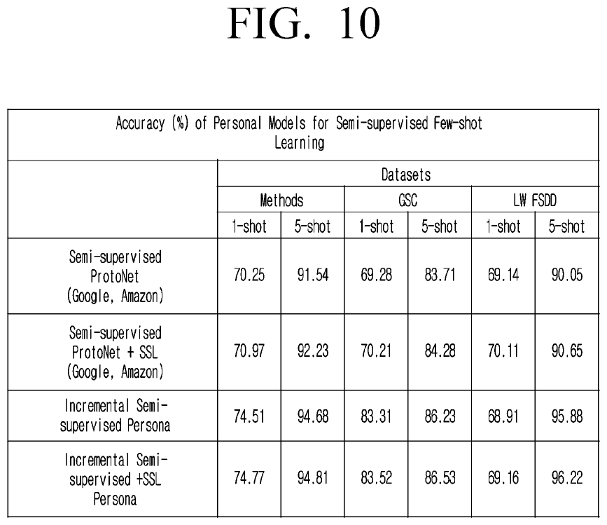

FIG. 10 is a table showing experimental results from training of personal ML models to perform few-shot incremental spoken word recognition, using semi-supervised learning and self-supervision.

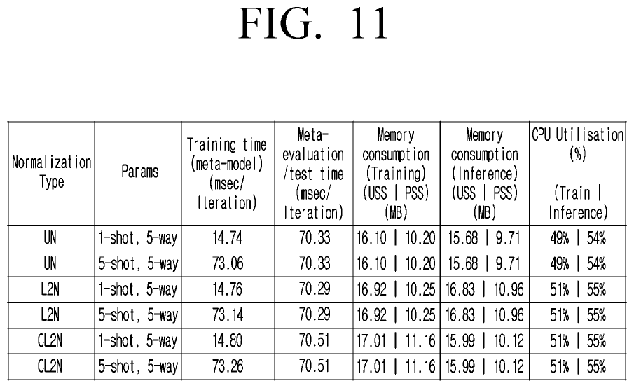

FIG. 11 is a table showing experimental results from training of personal ML models to perform few-shot incremental spoken word recognition using Pytorch and NNTrainer. Shared models are trained with Pytorch and exclusive personal models are trained using NNTrainer. The shared models are trained for 30-epochs and batch size of 100 samples using SGD optimizer. Size of the shared Conv4 model is 0.45 MB. In evaluation of exclusive personal models, 5 query samples per class and 2000 iterations are used. The GSC dataset of 20-classes, 18000-train samples, 3200-test samples is used.

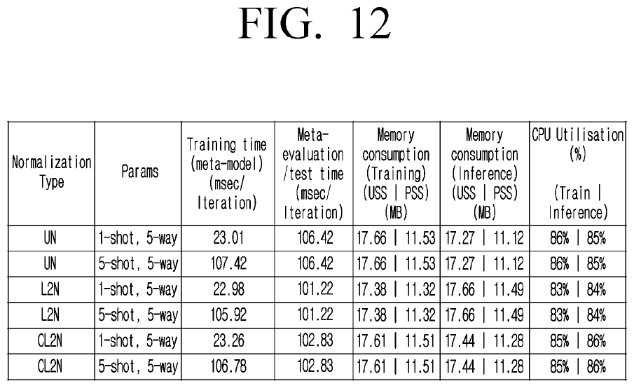

FIG. 12 is a table showing experimental results from training of personal ML models to perform few-shot incremental spoken word recognition using NNTrainer. Shared models and exclusive personal models are trained using NNTrainer. The shared models are trained for 30-epochs and batch size of 100 samples using SGD optimizer. Size of the shared Conv4 model is 0.48 MB. In evaluation of exclusive personal models, 5 query samples per class and 2000 iterations are used. The GSC dataset of 20-classes, 18000-train samples, and 3200-test samples, is used.

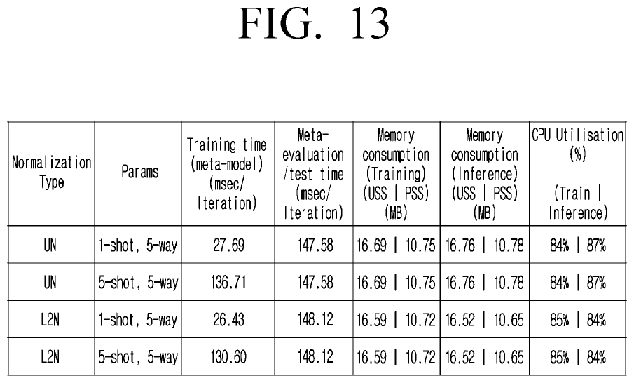

FIG. 13 is a table showing experimental results from training of personal ML models to perform few-shot incremental spoken word recognition using Pytorch and NNTrainer. Shared models are trained with Pytorch, and modular and exclusive personal models are trained using NNTrainer. The shared models are trained for 30-epochs and batch size of 100 samples using SGD optimizer. Size of the shared Conv4 model is 0.48 MB. Size of the modular personal model is 0.23 MB. It takes 10.61 minutes to train the modular personal model.

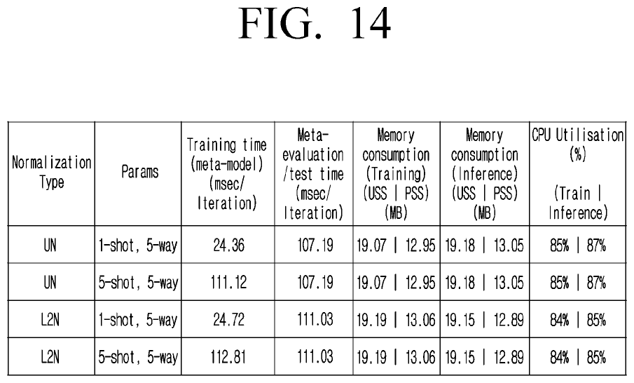

FIG. 14 is a table showing experimental results from training of personal ML models to perform few-shot incremental spoken word recognition using NNTrainer. Shared models, and modular and exclusive personal models are trained using NNTrainer. The shared models are trained for 30-epochs and batch size of 100 samples using SGD optimizer. Size of the shared Conv4 model is 0.48 MB. Size of the modular personal model is 0.23 MB. It takes 9.72 minutes to train the modular personal model.

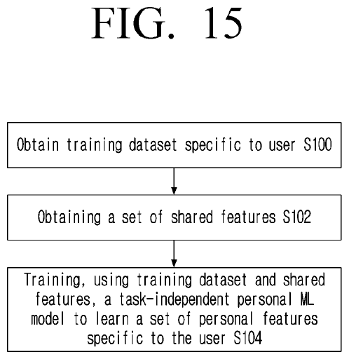

FIG. 15 is a flowchart of example steps required to train the task-independent personal ML model. The training method comprises: obtaining a training dataset specific to the user (S100); obtaining, from a task-independent shared ML model, a set of shared features (S102); and training, using the training dataset and set of shared features, the task-independent personal ML model to learn a set of personal features specific to the user (S104).

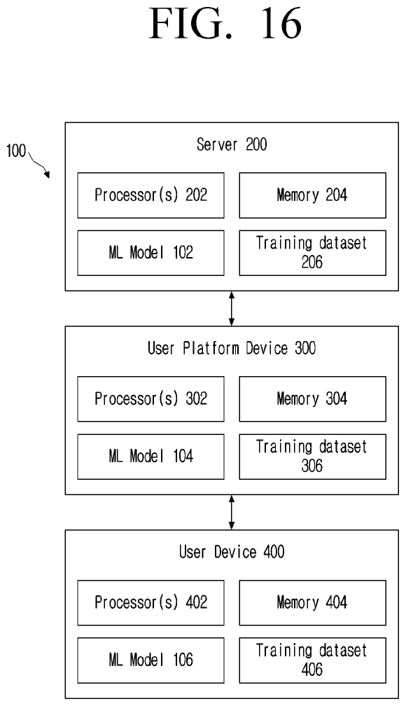

FIG. 16 is a block diagram of a system 100 for providing personal machine learning, ML, models for users. The system 100 comprises: a server 200, comprising a task-independent shared ML model 102; a user platform device 300, comprising a task-independent personal ML model 104 for a user; and a user device 400 comprising a task-specific personal ML model 106 for the user.

The server 200 comprises at least one processor 202 coupled to memory 204 for training the task-independent shared ML model 102 using a first training dataset 206. The at least one processor of the server trains the task-independent shared ML model to learn a set of shared features 108. The task-independent shared ML model comprises a feature extractor to extract features from data in the first training dataset, and a classifier to classify the extracted features. Training the task-independent shared ML model comprises using any one of the following: supervised learning, unsupervised learning, semi-supervised learning, and self-supervised learning.

The user platform device 300 comprises at least one processor 302 coupled to memory 304 for training the task-independent personal ML model 104 using a second training dataset 306. The at least one processor of the user platform device trains the task-independent personal ML model to learn a set of personal features 110 specific to the user. Training the task-independent personal ML model comprises using the shared features 108. The task-independent personal ML model comprises using an encoder to encode features of data in the second training dataset and the shared features, and decoder to decode the encoded features. The second training dataset comprises labelled data items, and training the task-independent personal ML model comprises using zero-shot or few-shot learning. Alternatively, the second training dataset comprises labelled and unlabelled data items, and training the task-independent personal ML model comprises using any one of the following: supervised learning, unsupervised training, semi-supervised training, and self-supervised learning.

The user device 400 comprises at least one processor 402 coupled to memory 404 for training the task-specific personal ML model 106 using a third training dataset 406. The at least one processor of the user device trains the task-specific personal ML model to learn a set of task-specific personal features specific to the user. Training the task-specific personal ML model comprises using the personal features 110. The third training dataset comprises labelled data items, and training the task-specific personal ML model comprises using zero-shot or few-shot learning. Alternatively, the third training dataset comprises labelled and unlabelled data items, and training the task-specific personal ML model comprises using any one of the following: supervised learning, unsupervised learning, semi-supervised learning, and self-supervised learning.

The ML models 102, 104, 106 may be trained to perform a computer vision task, such as, but not limited to: object recognition, object detection, object tracking, scene analysis, pose estimation, image or video segmentation, image or video synthesis, and image or video enhancement.

The ML models 102, 104, 106 may be trained to perform an audio analysis task, such as, but not limited to: audio recognition, audio classification, speech synthesis, speech processing, speech enhancement, speech-to-text, and speech recognition.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A system for providing personal machine learning, ML, models for users, the system comprising:
a server, comprising a task-independent shared ML model;
a user platform device, comprising a task-independent personal ML model for a user; and
a user device comprising a task-specific personal ML model for the user.

2. The system as claimed in claim 1, wherein the server comprises at least one processor coupled to memory for training the task-independent shared ML model using a first training dataset.

3. The system as claimed in claim 2, wherein the at least one processor of the server trains the task-independent shared ML model to learn a set of shared features.

4. The system as claimed in claim 2, wherein the task-independent shared ML model comprises a feature extractor to extract features from data in the first training dataset, and a classifier to classify the extracted features.

5. The system as claimed in claim 1, wherein training the task-independent shared ML model comprises using any one of the following: supervised learning, unsupervised learning, semi-supervised learning, and self-supervised learning.

6. The system as claimed in 1, wherein the user platform device comprises at least one processor coupled to memory for training the task-independent personal ML model using a second training dataset.

7. The system as claimed in claim 6, wherein the at least one processor of the user platform device trains the task-independent personal ML model to learn a set of personal features specific to the user.

8. The system as claimed in claim 6, when dependent on claim 4, wherein training the task-independent personal ML model comprises using the shared features.

9. The system as claimed in claim 8, wherein the task-independent personal ML model comprises using an encoder to encode features of data in the second training dataset and the shared features, and decoder to decode the encoded features.

10. The system as claimed in claim 6, wherein the second training dataset comprises labelled data items, and training the task-independent personal ML model comprises using zero-shot or few-shot learning.

11. The system as claimed in claim 6, wherein the second training dataset comprises labelled and unlabelled data items, and training the task-independent personal ML model comprises using any one of the following: supervised learning, unsupervised learning, semi-supervised learning, and self-supervised learning.

12. The system as claimed in claim 1, wherein the user device comprises at least one processor coupled to memory for training the task-specific personal ML model using a third training dataset.

13. The system as claimed in claim 12 wherein the at least one processor of the user device trains the task-specific personal ML model to learn a set of task-specific personal features specific to the user.

14. The system as claimed in claim 13, when dependent on claim 7, wherein training the task-specific personal ML model comprises using the personal features.

15. The system as claimed in claim 12, wherein the third training dataset comprises labelled data items, and training the task-specific personal ML model comprises using zero-shot or few-shot learning.

16. A computer-implemented method training task-independent personal machine learning, ML, models for a user, the method comprising:
obtaining a training dataset specific to the user;
obtaining, from a task-independent shared ML model, a set of shared features; and
training, using the training dataset and set of shared features, the task-independent personal ML model to learn a set of personal features specific to the user.

17. The method as claimed in claim 11, wherein the training comprises:
using an encoder to encode features of data in the training dataset and the shared features, and
using a decoder to decode the encoded features.

18. The method as claimed in claim 11, wherein the training dataset comprises labelled data items, and wherein the training comprises using zero-shot or few-shot learning.

19. The method as claimed in claim 11, wherein the training dataset comprises labelled and unlabelled data items, and wherein the training comprises using any one of the following: supervised learning, unsupervised learning, semi-supervised learning, and self-supervised learning.

20. A non-transitory computer readable medium for storing computer readable program code or instructions which are executable by a processor to perform a method for suggesting at least one modality of interaction, the method comprising:
obtaining a training dataset specific to the user;
obtaining, from a task-independent shared ML model, a set of shared features; and
training, using the training dataset and set of shared features, the task-independent personal ML model to learn a set of personal features specific to the user.
